(19) United States
(12) Patent Application Publication
(10) Pub. No.: US 2025/0080902 A1
(43) Pub. Date: Mar. 6, 2025

(54) ESTIMATION DEVICE, ESTIMATION METHOD, AND COMPUTER PROGRAM PRODUCT

(71) Applicants: KABUSHIKI KAlSHA TOSHlBA, Tokyo (JP); TOSHIBA DIGITAL SOLUTIONS CORPORATION, Kawasaki-shi (JP)

(72) Inventors: Yusaku KIKUGAWA, Nishitama (JP); Naoki HIRAYAMA, Kawasaki, Kanagawa (JP)

(73) Assignees: KABUSHIKI KAlSHA TOSHlBA, Tokyo (JP); TOSHIBA DIGITAL SOLUTIONS CORPORATION, Kawasaki-shi (JP)

(21) Appl. No.: 18/816,219

(22) Filed: Aug. 27, 2024

(30) Foreign Application Priority Data
Aug. 28, 2023 (JP) 2023-137957

(51) Int. Cl. H04R 1/32; G10L 15/22

(52) U.S. Cl. CPC H04R 1/326; G10L 15/22

(57) ABSTRACT

According to one embodiment, an estimation device includes one or more hardware processors configured to function as: a conversion module configured to perform time frequency conversion on acoustic signals of a plurality of channels to acquire a frequency spectrum; a spatial correlation calculation module configured to calculate a spatial correlation matrix from the frequency spectrum; a spatial correlation filter module configured to calculate a spatial correlation filter from the spatial correlation matrix; and a direction estimation module configured to estimate general direction information from a partial element included in the spatial correlation filter.

### CROSS-REFERENCE TO RELATED APPLICATIONS

This application is based upon and claims the benefit of priority from Japanese Patent Application No. 2023-137957, filed on Aug. 28, 2023; the entire contents of which are incorporated herein by reference.

### FIELD

Embodiments described herein relate generally to an estimation device, an estimation method, and a computer program product.

### BACKGROUND

There is conventionally known a method of frequency-converting acoustic signals input from a plurality of microphones and performing beam forming from the frequency-converted time frequency conversion signals by using a spatial correlation filter based on target sound source direction information indicating a direction to a target sound source included in the acoustic signals.

However, in the conventional art, it is difficult to robustly estimate the arrival direction of sound from a sound source with lower computational cost.

### BRIEF DESCRIPTION OF THE DRAWINGS

FIG. 1 is a diagram illustrating an arrangement example of a plurality of microphones according to a first embodiment;

FIG. 2 is a diagram illustrating an example of a functional configuration of an estimation device according to the first embodiment;

FIG. 3A is a diagram explaining a phase spectrum;

FIG. 3B is a diagram explaining the phase spectrum;

FIG. 4 is a diagram illustrating an example of a spatial correlation filter and its application example according to the first embodiment;

FIG. 5 is a diagram illustrating an example of a functional configuration of a direction estimation module according to the first embodiment;

FIG. 6A is a diagram illustrating a first estimation example of general direction information according to the first embodiment;

FIG. 6B is a diagram illustrating a second estimation example of the general direction information according to the first embodiment;

FIG. 7 is a flowchart illustrating an example of an estimation method according to the first embodiment;

FIG. 8 is a diagram illustrating an example of a functional configuration of a direction estimation module according to a second embodiment;

FIG. 9 is a flowchart illustrating an example of an estimation method according to the second embodiment; and

FIG. 10 is a diagram illustrating an example of a hardware configuration of the estimation device according to the first and second embodiments.

### DETAILED DESCRIPTION

In general, according to one embodiment, an estimation device includes one or more hardware processors configured to function as a conversion module, a spatial correlation calculation module, a spatial correlation filter module, and a direction estimation module. The conversion module is configured to perform time frequency conversion on acoustic signals of a plurality of channels to acquire a frequency spectrum. The spatial correlation calculation module is configured to calculate a spatial correlation matrix from the frequency spectrum. The spatial correlation filter module is configured to calculate a spatial correlation filter from the spatial correlation matrix. The direction estimation module is configured to estimate general direction information from a partial element included in the spatial correlation filter.

Exemplary embodiments of an estimation device, an estimation method, and a computer program product will be explained below in detail with reference to the accompanying drawings. The present invention is not limited to the following embodiments.

### First Embodiment

A case where a notification result of a voice recognition pattern etc. is controlled does not require beam forming, and general direction information such as the left and right estimation may be obtained, for example. Moreover, when a target sound source is not completely fixed and moves slightly, or when a distance between microphones is changed, for example, strict direction estimation may not be useful. On the other hand, direction determination may be required to be robust for ambient noise.

Hereinafter, an estimation device according to the first embodiment that can save computational cost and enhance noise immunity will be described.

At first, an arrangement example of a plurality of microphones according to the first embodiment will be described.

### Arrangement Example of Plurality of Microphones

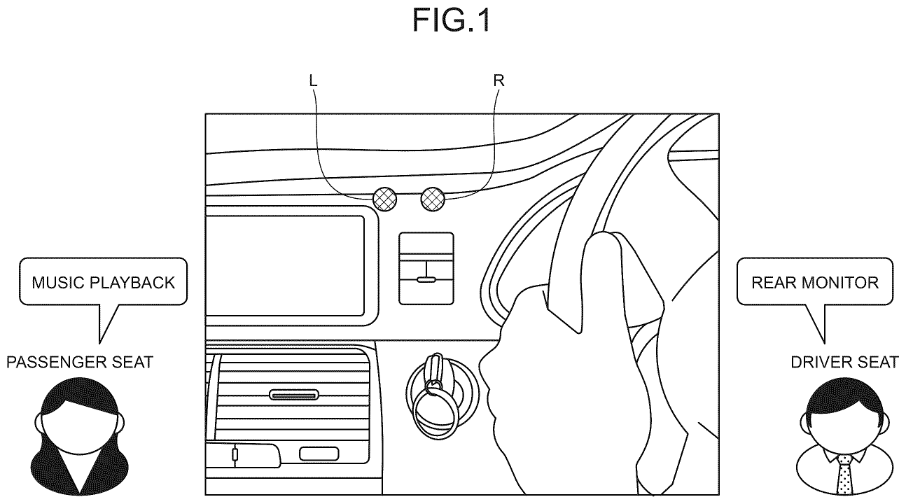

FIG. 1 is a diagram illustrating an arrangement example of a plurality of microphones L and R according to the first embodiment. An example illustrated in FIG. 1 illustrates an automotive use case. The estimation device according to the first embodiment estimates a general arrival direction (left or right in the example of FIG. 1) of a sound source from information acquired by the two microphones L and R. The general arrival direction of the sound source is utilized for device control by a keyword detected by voice recognition, for example.

Specifically, for example, an in-vehicle entertainment operation (for example, operation by voice input of a user such as “music playback”) such as music, television, and radio can consider device control that responds to anyone's voice. In the example of FIG. 1, the device control by the in-vehicle entertainment operation responds to both of a voice (i.e., voice of user sitting in passenger seat) coming from the right and a voice (i.e., voice of driver sitting in driver seat) coming from the left.

Moreover, for example, driving assistance control by a keyword (e.g., “rear monitor” etc.) of the driving operation can consider a case where the control responds to only a voice of the driver of the driver seat. In the example of the driving assistance control illustrated in FIG. 1, the control responds to a voice (i.e., voice of driver sitting in driver seat) coming from the left and does not respond to a voice (i.e., voice of user sitting in passenger seat) coming from the right.

Note that the estimation device according to the first embodiment can also estimate general arrival directions such as the up and down and the front and rear as well as the left and right depending on the arrangement of the plurality of microphones. Moreover, the number of the plurality of microphones (the plurality of channels) is not limited to two, and may be three or more.

### Example of Functional Configuration

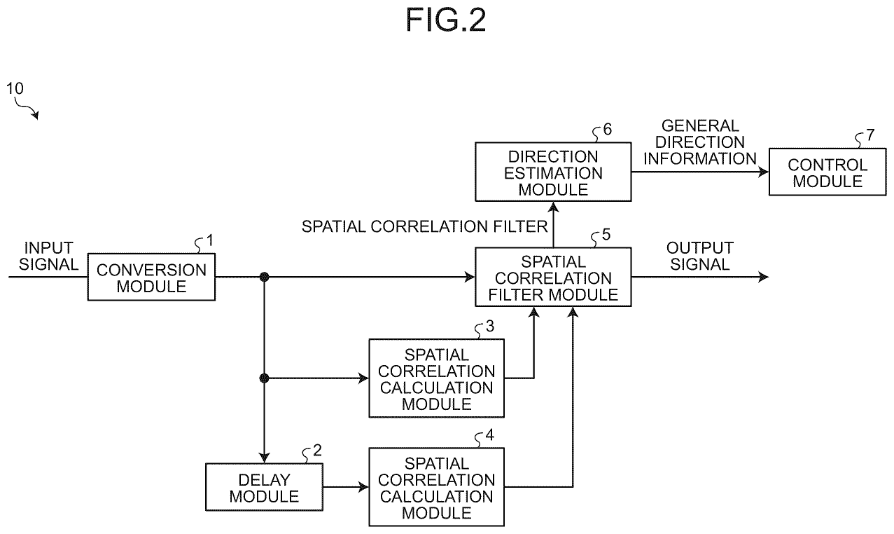

FIG. 2 is a diagram illustrating an example of a functional configuration of an estimation device 10 according to the first embodiment. The estimation device 10 according to the first embodiment includes a conversion module 1, a delay module 2, a spatial correlation calculation module 3, a spatial correlation calculation module 4, a spatial correlation filter module 5, a direction estimation module 6, and a control module 7.

The conversion module 1 converts an acoustic signal input from the microphone L into a frequency spectrum X[0] [size] by performing time frequency conversion. Herein, [0] indicates the number of channels indicating the input from the microphone L. [size] indicates a number of a frequency bin. For example, the time frequency conversion is calculated by a process such as fast Fourier transform and discrete Fourier transform.

Similarly, the conversion module 1 converts an acoustic signal input from the microphone R into a frequency spectrum X[1] [size] by performing time frequency conversion. Herein, [1] indicates the number of channels indicating the input from the microphone R.

Hereinafter, when the frequency spectrum X[0] [size] and the frequency spectrum X[1] [size] are not distinguished, they are expressed with a frequency spectrum X[ch] [size].

A component of the frequency spectrum X[ch] [size], that is, a component of the time-frequency converted acoustic signal is expressed with a complex spectrum like Expression (1).

$$X [ ch ] [ size ] = X [ ch ] [ size ] . re + X [ ch ] [ size ] . im \qquad ( 1 )$$

Herein, “re” indicates a real part, and “im” indicates an imaginary part. For example, the complex spectrum is used for the calculation of a power spectrum (amplitude component every frequency) by Expression (2), a phase spectrum (phase component every frequency) by Expression (3), and the like.

$$\vert x [ ch ] \vert = \sqrt{X [ ch ] . {re}^{2} + X [ ch ] . {im}^{2}} \qquad ( 2 )$$

$${θ}_{ch} = {tan}^{- 1} \frac{X [ ch ] . im}{X [ ch ] . re} \qquad ( 3 )$$

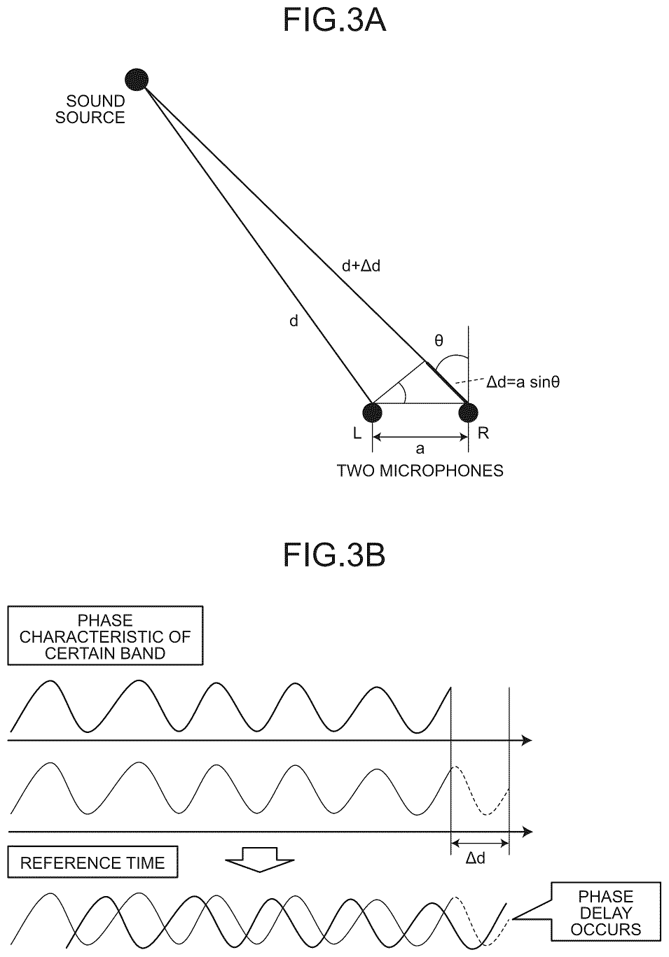

FIGS. 3A and 3B are diagrams explaining a phase spectrum. The phase spectrum is an index that indicates how far an acoustic signal progresses (or causes delay) from a reference time. As illustrated in FIG. 3A, when the arrival directions of sound from the sound source have a direction difference, arrival distances up to the microphones L and R are different by Δd. For that reason, an acoustic signal reaching the microphone R has a phase delay Δd as illustrated in FIG. 3B.

Returning to FIG. 2, when accepting the frequency spectrum X[ch] [size] from the conversion module 1, the delay module 2 delays the frequency spectrum X[ch] [size] by a predetermined time. A delay time may be set so that a duration of command word utterance that is a voice to be emphasized is roughly equal to or less than the delay time. When a command word is a short word such as “switch-on”, it can be assumed that the duration of the command word utterance is equal to or less than one second. In this case, the delay time is set to one second, for example. The delay time of one second is equal to the number of delay frames of 125 (=16000× 1/128). In other words, the delay module 2 buffers the frequency spectrum X[ch] [size] for 125 frames, and outputs the frequency spectrum X[ch] [size] that is delayed by 125 frames.

Based on the frequency spectrum X[ch] [size], the spatial correlation calculation module 3 calculates a spatial correlation matrix of voice and noise. The spatial correlation matrix is information that indicates a spatial correlation between channels, and expresses a spatial energy distribution. Specifically, the spatial correlation calculation module 3 first calculates a mixing matrix signal Conv[size][f] from the time-frequency converted acoustic signal (frequency spectrum X[ch] [size]). The mixing matrix Conv[size] [f] is calculated to mix information of a plurality of channels like Expression (4).

$$Conv [ size ] [ {f}_{1} ] = X [ 0 ] [ size ] . Re * X [ 0 ] [ size ] . Re + X [ 0 ] [ size ] . Im * X [ 0 ] [ size ] . Im \\ Conv [ size ] [ {f}_{2} ] = X [ 1 ] [ size ] . Re * X [ 1 ] [ size ] . Re + X [ 1 ] [ size ] . Im * X [ 1 ] [ size ] . Im \\ Conv [ size ] [ {f}_{3} ] = X [ 0 ] [ size ] . Re * X [ 1 ] [ size ] . Re + X [ 0 ] [ size ] . Im * X [ 1 ] [ size ] . Im \\ Conv [ size ] [ {f}_{4} ] = X [ 0 ] [ size ] . Re * X [ 1 ] [ size ] . Re + X [ 0 ] [ size ] . Im * X [ 1 ] [ size ] . Im \qquad ( 4 )$$

Herein, “f” indicates an element number. Note that the mixing matrix signal has an element that includes information on all the plurality of channels. In Expression (4), the mixing matrix whose element numbers are f₃ and f₄ has information that includes a phase difference between the plurality of channels (channels 0 and 1 in the first embodiment).

Next, the spatial correlation calculation module 3 calculates spatial correlation matrices Φs[size] [f] and Φn[size] [f] from the mixing matrix Conv[size] [f] by using Expression (5). Herein, “s” indicates a signal, and “n” indicates noise.

$$ϕ s [ size ] [ f ] = α * σ s [ size ] [ f ] + ( 1 - α ) * conv [ size ] [ f ] \\ ϕ n [ size ] [ f ] = β * σ n [ size ] [ f ] + ( 1 - β ) * Δ conv [ size ] [ f ] \qquad ( 5 )$$

Similarly, based on the frequency spectrum X[ch] [size] received from the delay module 2, the spatial correlation calculation module 4 calculates a spatial correlation matrix of voice and noise. Like the spatial correlation calculation modules 3 and 4 according to the first embodiment, a plurality of spatial correlation matrix signals may be calculated. For example, the spatial correlation matrix at the present time calculated by the spatial correlation calculation module 3 may be set as a spatial correlation matrix signal component, and the spatial correlation matrix before a certain time (before the predetermined number of frames) calculated by the spatial correlation calculation module 4 may be set as a spatial correlation noise component (details refer to Japanese Patent No. 7191793).

Note that, when the calculation of the spatial correlation matrix before the certain time (before the predetermined number of frames) is not performed, the delay module 2 and the spatial correlation calculation module 4 may not be included in the estimation device 10.

Based on the spatial correlation matrices Φs[size] [f] and Φn[size] [f], the spatial correlation filter module 5 calculates one or more spatial correlation filters (two spatial correlation filters in the first embodiment). Specifically, the spatial correlation filter module 5 first calculates an eigenvalue vector signal from the spatial correlation matrices Φs[size] [f] and Φn[size] [f] signals. To suppress a processing load in calculating the eigenvalue vector signal, the eigenvalue vector may be an eigenvalue vector of about two dimensions like a two-dimensional eigenvalue vector M [size] of Expression (6).

$$M [ size ] [ 0 ] [ 0 ] . Re = ϕ n [ size ] [ {f}_{2} ] * ϕ s [ size ] [ {f}_{1} ] - ϕ n [ size ] [ {f}_{3} ] * σ s [ size ] [ {f}_{3} ] + ϕ n [ size ] [ {f}_{4} ] * ϕ s [ size ] [ {f}_{4} ] \\ M [ size ] [ 0 ] [ 0 ] . Im = σ n [ size ] [ {f}_{3} ] * ϕ s [ size ] [ {f}_{4} ] - ϕ n [ size ] [ {f}_{4} ] * σ s [ size ] [ {f}_{3} ] \qquad ( 6 )$$

$$M [ size ] [ 0 ] [ 1 ] . Re = ϕ n [ size ] [ {f}_{2} ] * ϕ s [ size ] [ {f}_{3} ] - ϕ n [ size ] [ {f}_{3} ] * σ s [ size ] [ {f}_{2} ] \\ M [ size ] [ 0 ] [ 1 ] . Im = σ n [ size ] [ {f}_{2} ] * ϕ s [ size ] [ {f}_{4} ] - ϕ n [ size ] [ {f}_{4} ] * σ s [ size ] [ {f}_{2} ]$$

$$M [ size ] [ 1 ] [ 0 ] . Re = ϕ n [ size ] [ {f}_{3} ] * ϕ s [ size ] [ {f}_{1} ] - ϕ n [ size ] [ {f}_{1} ] * σ s [ size ] [ {f}_{3} ] \\ M [ size ] [ 1 ] [ 0 ] . Im = σ n [ size ] [ {f}_{4} ] * ϕ s [ size ] [ {f}_{1} ] - ϕ n [ size ] [ {f}_{1} ] * σ s [ size ] [ {f}_{4} ]$$

$$M [ size ] [ 1 ] [ 1 ] . Re = ϕ n [ size ] [ {f}_{1} ] * ϕ s [ size ] [ {f}_{2} ] - ϕ n [ size ] [ {f}_{3} ] * σ s [ size ] [ {f}_{3} ] - ϕ n [ size ] [ {f}_{4} ] * ϕ s [ size ] [ {f}_{4} ] \\ M [ size ] [ 1 ] [ 1 ] . Im = σ n [ size ] [ {f}_{3} ] * ϕ s [ size ] [ {f}_{4} ] + ϕ n [ size ] [ {f}_{4} ] * σ s [ size ] [ {f}_{3} ]$$

For each element, the eigenvalue vector has an element that includes all information of the plurality of channels. In the example of Expression (6), any of eigenvalues M that use the mixing matrix whose element numbers are f₃ and f₄ include phase difference information.

Next, the spatial correlation filter module 5 calculates a spatial correlation filter coefficient from the eigenvalue vector signal. For example, when taken as a two-dimensional eigenvalue, four element components are generated.

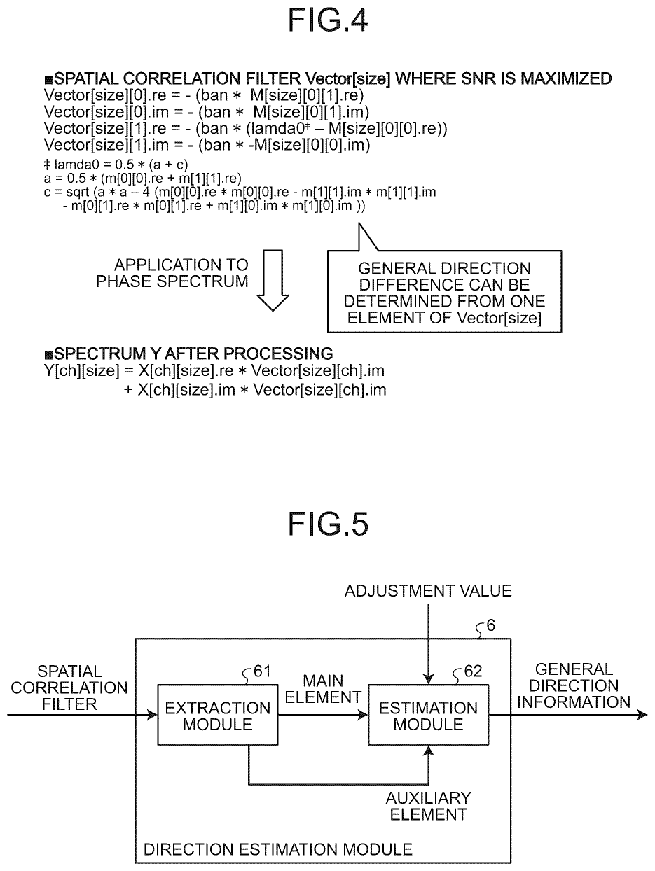

FIG. 4 is a diagram illustrating an example of a spatial correlation filter Vector [size] and its application example according to the first embodiment. In the example of FIG. 4, the spatial correlation filter coefficient is calculated so that a signal/noise ratio (SNR) of a signal component at the present time is maximized.

Note that a general direction difference can be determined from one element of the spatial correlation filter Vector [size]. The details of a determination method of the general direction difference will be described later with reference to FIG. 5.

Moreover, the spatial correlation filter Vector [size] may use a plurality of elements. For example, one or more elements of the spatial correlation filter Vector [size] may be used for parameter adjustment of general direction estimation.

Moreover, the present-time signal can be emphasized by multiplying the spatial correlation filter Vector [size] by each element of the time-frequency converted acoustic signal.

Returning to FIG. 2, the direction estimation module 6 estimates general direction information from the partial element of the one or more spatial correlation filters. The general direction information is general information such as left/right information, instead of strict direction information. For example, the general direction information includes a direction indicated by an angle of θ or −θ, left or right, front or rear, top or bottom, and the like.

For example, the general direction information is used for the control of result notification of recognition pattern, etc. Note that resistance characteristics from ambient noise can be enhanced by using the spatial correlation filter obtained from the spatial correlation matrix of voice and noise. Moreover, because it is limited to estimating the general direction information, computational cost can be saved. Moreover, the estimation of the general direction information is not easily affected by the distance between microphones and the target sound source movement.

The control module 7 changes the control by a voice recognition pattern recognized from the acoustic signals based on the general direction information. For example, the control module 7 estimates whether the acoustic signal is a voice from the driver seat or a voice from the passenger seat from the general direction information, and changes the control by the voice recognition pattern based on the estimation result.

FIG. 5 is a diagram illustrating an example of a functional configuration of the direction estimation module 6 according to the first embodiment. The direction estimation module 6 according to the first embodiment includes an extraction module 61 and an estimation module 62.

The extraction module 61 extracts one element of the spatial correlation filter coefficient as a main element. As described above, when taken as a two-dimensional eigenvalue, four element components are generated. The extraction module 61 narrows down four element components to one element. Specifically, the extraction module 61 extracts an element, which includes information (e.g., information indicating a phase difference between the plurality of channels) of all the plurality of channels, as a main element. When there are a plurality of elements of which each includes information of all the plurality of channels, the extraction module 61 may uniquely extract the elements from the effects (estimation accuracy of general direction information), and extract or change one element afterward.

The extraction module 61 may extract not only one type of element and simultaneously extract but also the plurality of elements, and calculate a difference between them etc. Moreover, the extraction module 61 may extract an auxiliary element other than the main element, and the estimation module 62 may weight the auxiliary element to correct local direction information.

Based on “the main element” or “the main element and auxiliary element” extracted by the extraction module 61, the estimation module 62 outputs the estimated local direction as the general direction information. For example, the estimation module 62 specifies a trend of a specific frequency in a specific time from the main element, estimates local direction information indicated by the trend, and outputs general direction information based on the local direction information. Specifically, because the main element of the spatial correlation filter coefficient is information for each frequency, the estimation module 62 sums and average main elements in the unified frequency band. Then, the estimation module 62 outputs the local direction information indicating the averaged main element as the general direction information.

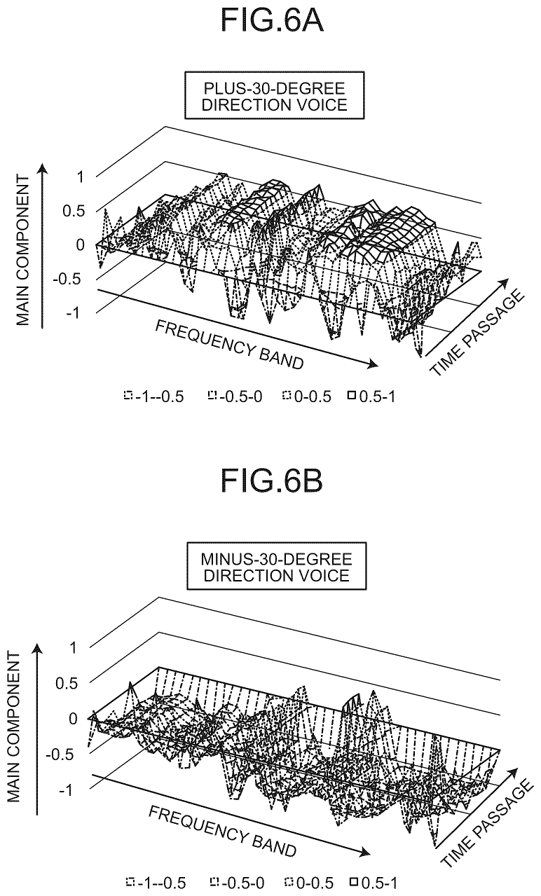

FIGS. 6A and 6B are diagrams illustrating first and second estimation examples of the general direction information according to the first embodiment. The values of main components of FIGS. 6A and 6B indicate local direction information obtained from a partial element (e.g., one element) included in the spatial correlation filter. The local direction information includes the trend of the specific frequency in the specific time. FIGS. 6A and 6B illustrate cases where the general direction information estimated from the main element of the spatial correlation filter is a plus-30-degree direction and a minus-30-degree direction.

The estimation module 62 estimates the local direction information depending on whether the trend of the specific frequency in the specific time is larger than a predetermined value. In the example of FIGS. 6A and 6B, the predetermined value is 0.

In FIG. 6A, the main component indicating the local direction has more plus values than minus values. For that reason, when the local direction information of FIG. 6A is obtained, the estimation module 62 estimates that the main component is a voice (e.g., voice from passenger seat) in the plus-30-degree direction.

On the other hand, in FIG. 6B, the main component indicating the local direction has more minus values than plus values. For that reason, when the local direction information of FIG. 6B is obtained, the estimation module 62 estimates that the main component is a voice (e.g., voice from driver seat) in the minus-30-degree direction.

Note that the estimation module 62 may add an arbitrary adjustment value to the local direction information. The threshold of the determination can be adjusted by adding the adjustment value. For example, in the example of FIGS. 6A and 6B, which of a voice in the plus-30-degree direction and a voice in the minus-30-degree direction corresponds to the main component of the values near 0 can be adjusted by the adjustment value. The estimation accuracy of the general direction information can be further improved by the adjustment value.

Moreover, the unified frequency band may include all bands from the low band to the high band, or may include only a voice band range that includes many voice components. In addition, the estimation module 62 may provide weighting to the specific frequency component. Moreover, the estimation module 62 may average the local direction information in a time direction. The local direction can be output as the more general direction by the averaging.

### Example of Estimation Method

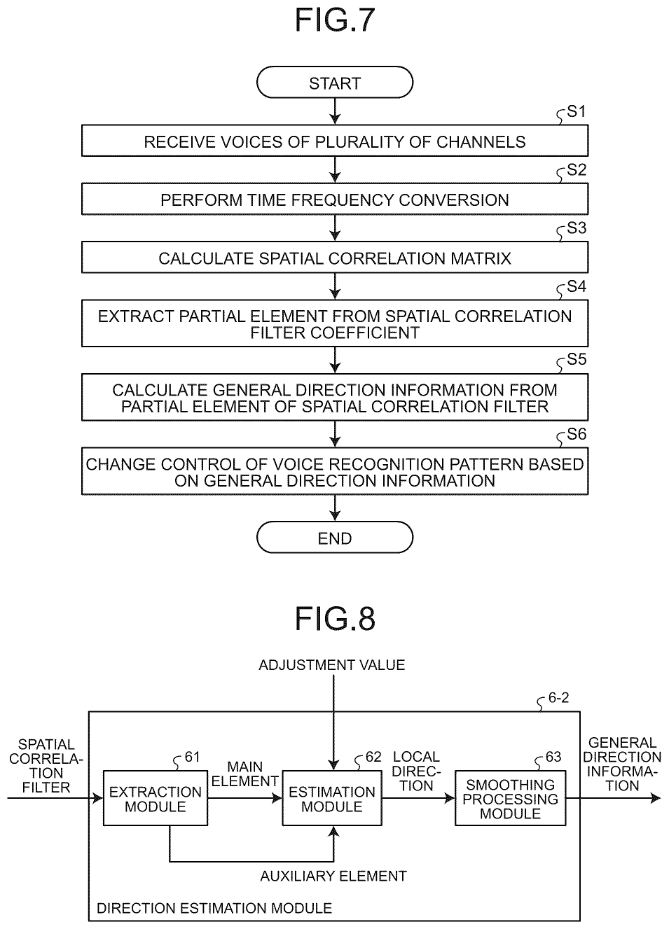

FIG. 7 is a flowchart illustrating an example of an estimation method according to the first embodiment. At first, the conversion module 1 receives voices (acoustic signals) of a plurality of channels (Step S1), and performs time frequency conversion on the received acoustic signals (Step S2). Next, based on a frequency spectrum X[ch][size] obtained by the time frequency conversion, the spatial correlation calculation module 3 calculates a spatial correlation matrix of voice and noise (Step S3).

Next, the extraction module 61 extracts a partial element (e.g., one element) of a spatial correlation filter coefficient as a main element (Step S4). Next, the estimation module 62 calculates general direction information from the partial element included in the spatial correlation filter (Step S5).

Next, the control module 7 changes control of a voice recognition pattern based on the general direction information (Step S6).

As described above, in the estimation device 10 according to the first embodiment, the conversion module 1 performs the time frequency conversion on the acoustic signals of the plurality of channels to acquire the frequency spectrum. The spatial correlation calculation module 3 calculates the spatial correlation matrix from the frequency spectrum. The spatial correlation filter module 5 calculates the spatial correlation filter from the spatial correlation matrix. Then, the direction estimation module 6 estimates the general direction information from the partial element included in the spatial correlation filter.

Thus, according to the estimation device 10 of the first embodiment, the arrival direction of the sound source can be robustly estimated with lower computational cost.

### Second Embodiment

Next, a second embodiment will be described. In explanation according to the second embodiment, the same explanation as the first embodiment is omitted, and a difference from the first embodiment will be described.

### Example of Functional Configuration

FIG. 8 is a diagram illustrating an example of a functional configuration of a direction estimation module 6-2 according to the second embodiment. The direction estimation module 6-2 according to the second embodiment includes the extraction module 61, the estimation module 62, and a smoothing processing module 63. In the second embodiment, the smoothing processing module 63 is further added to the configuration according to the first embodiment.

Based on the partial element extracted by the extraction module 61, the estimation module 62 estimates a local direction indicated by the trend of the specific frequency in the specific time.

The smoothing processing module 63 adjusts the local direction information obtained by the estimation module 62, and eventually outputs the adjusted local direction information as the general direction information. For example, the smoothing processing module 63 smoothing-corrects the local direction information in at least one of a time direction and a band direction, and outputs the general direction information based on the smoothing-corrected local direction information. By smoothing-correcting the local direction information in at least one (time direction, band direction, or both) of the time direction and the band direction, the stringency of the estimation result of the direction information can be further reduced. As a result, it is possible to output the general direction information that is further resistant to disturbance factors.

### Example of Estimation Method

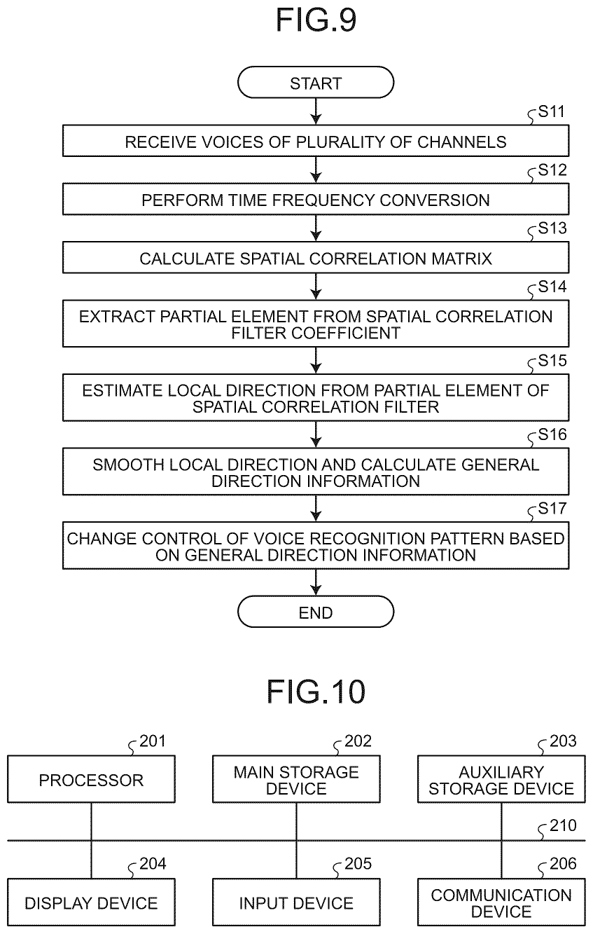

FIG. 9 is a flowchart illustrating an example of an estimation method according to the second embodiment. Because Steps S11 to S14 are the same as Steps S1 to S4 according to the first embodiment, their descriptions are omitted.

Based on the partial element extracted by the extraction module 61, the estimation module 62 estimates a local direction including a trend of a specific frequency in a specific time (Step S15).

Next, the smoothing processing module 63 smooths the local direction obtained by the estimation module 62, and calculates general direction information (Step S16).

Because Step S17 is the same as Step S6 according to the first embodiment, its description is omitted.

Finally, an example of a hardware configuration of the estimation device 10 according to the first and second embodiments will be described.

### Example of Hardware Configuration

FIG. 10 is a diagram illustrating an example of a hardware configuration of the estimation device 10 according to the first and second embodiments. The estimation device 10 according to the first and second embodiments includes a processor 201, a main storage device 202, an auxiliary storage device 203, a display device 204, an input device 205, and a communication device 206. The processor 201, the main storage device 202, the auxiliary storage device 203, the display device 204, the input device 205, and the communication device 206 are connected via a bus 210.

Note that the estimation device 10 may not include some of the above configuration. For example, when the estimation device 10 can use an input function and a display function of an external device, the estimation device 10 may not include the display device 204 and the input device 205.

The processor 201 executes a program read into the main storage device 202 from the auxiliary storage device 203. The main storage device 202 is a memory such as ROM and RAM. The auxiliary storage device 203 is a hard disk drive (HDD), a memory card, or the like.

The display device 204 is a liquid crystal display, for example. The input device 205 is an interface for operating the estimation device 10. Note that the display device 204 and the input device 205 may be realized by a touch panel etc. that has a display function and an input function. The communication device 206 is an interface for communicating with another device.

For example, a program to be executed by the estimation device 10 is recorded in a computer-readable storage medium such as a memory card, a hard disk, CD-RW, CD-ROM, CD-R, DVD-RAM, and DVD-R in an installable format or executable format file, and is provided as a computer program product.

Moreover, for example, a program to be executed by the estimation device 10 may be configured to be provided by being stored on a computer connected to a network such as the Internet and being downloaded by way of the network.

Moreover, for example, a program to be executed by the estimation device 10 may be configured to be provided by way of a network such as the Internet without downloading the program. Specifically, it may be configured to execute an estimation process by using a so-called ASP (application service provider) service that realizes a processing function by only the execution instruction and result acquisition without transferring the program from a server computer.

Moreover, for example, the program of the estimation device 10 may be configured to be provided by being previously incorporated into ROM etc.

A program to be executed by the estimation device 10 has a module configuration including functions, which can also be executed by the program, within the above functional configuration. For these functions, from the viewpoint of actual hardware, the processor 201 reads a program from a storage medium and executes the program, and thus the functional blocks are loaded on the main storage device 202. In other words, the functional blocks are generated on the main storage device 202.

Note that some or all of the functions described above may be realized by hardware such as IC (integrated circuit) without realizing them by software.

Moreover, functions may be realized by a plurality of the processors 201. In that case, each of the processors 201 may realize one of the functions, or may realize two or more of the functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An estimation device comprising:
one or more hardware processors configured to function as:
a conversion module configured to perform time frequency conversion on acoustic signals of a plurality of channels to acquire a frequency spectrum;
a spatial correlation calculation module configured to calculate a spatial correlation matrix from the frequency spectrum;
a spatial correlation filter module configured to calculate a spatial correlation filter from the spatial correlation matrix; and
a direction estimation module configured to estimate general direction information from a partial element included in the spatial correlation filter.

2. The estimation device according to claim 1, wherein
the direction estimation module includes:
an extraction module configured to extract, from the spatial correlation filter, a main element including information that indicates a phase difference between the plurality of channels; and
an estimation module configured to specify a trend of a specific frequency in a specific time from the main element, estimate local direction information indicated by the trend, and output the general direction information based on the local direction information.

3. The estimation device according to claim 1, wherein
the direction estimation module includes:
an extraction module configured to extract, from the spatial correlation filter, a main element including information that indicates a phase difference between the plurality of channels;
an estimation module configured to specify a trend of a specific frequency in a specific time from the main element, and estimate local direction information indicated by the trend; and
a smoothing processing module configured to smoothing-correct the local direction information in at least one of a time direction and a band direction, and output the general direction information based on the smoothing-corrected local direction information.

4. The estimation device according to claim 2, wherein
the estimation module is configured to estimate the local direction information depending on whether the trend of the specific frequency in the specific time is larger than a predetermined value.

5. The estimation device according to claim 3, wherein
the estimation module is configured to estimate the local direction information depending on whether the trend of the specific frequency in the specific time is larger than a predetermined value.

6. The estimation device according to claim 4, wherein
the estimation module is configured to adjust the predetermined value by using an adjustment value for improving estimation accuracy of the general direction information.

7. The estimation device according to claim 5, wherein
the estimation module is configured to adjust the predetermined value by using an adjustment value for improving estimation accuracy of the general direction information.

8. The estimation device according to claim 1, wherein
the general direction information indicates one of a direction indicated by an angle of +θ or −θ, left or right, front or rear, and top or bottom.

9. The estimation device according to claim 2, wherein
the general direction information indicates one of a direction indicated by an angle of +θ or −θ, left or right, front or rear, and top or bottom.

10. The estimation device according to claim 3, wherein
the general direction information indicates one of a direction indicated by an angle of +θ or −θ, left or right, front or rear, and top or bottom.

11. The estimation device according to claim 1, wherein
the one or more hardware processors are further configured to function as a control module configured to change control by a voice recognition pattern recognized from the acoustic signals based on the general direction information.

12. The estimation device according to claim 2, wherein
the one or more hardware processors are further configured to function as a control module configured to change control by a voice recognition pattern recognized from the acoustic signals based on the general direction information.

13. The estimation device according to claim 3, wherein
the one or more hardware processors are further configured to function as a control module configured to change control by a voice recognition pattern recognized from the acoustic signals based on the general direction information.

14. An estimation method comprising:
performing, by an estimation device, time frequency conversion on acoustic signals of a plurality of channels to acquire a frequency spectrum;
calculating, by the estimation device, a spatial correlation matrix from the frequency spectrum;
calculating, by the estimation device, a spatial correlation filter from the spatial correlation matrix; and
estimating, by the estimation device, general direction information from a partial element included in the spatial correlation filter.

15. A computer program product having a non-transitory computer readable medium including instructions stored thereon, wherein the instructions, when executed by a computer, cause the computer to perform:
performing time frequency conversion on acoustic signals of a plurality of channels to acquire a frequency spectrum;
calculating a spatial correlation matrix from the frequency spectrum;
calculating a spatial correlation filter from the spatial correlation matrix; and
estimating general direction information from a partial element included in the spatial correlation filter.
